(19) United States
(12) Patent Application Publication
(10) Pub. No.: US 2004/0266420 A1
(43) Pub. Date: Dec. 30, 2004

(54) System and method for secure mobile connectivity

(75) Inventors: Jari T. Malinen, Sunnyvale, CA (US); John J. Cruz, Sunnyvale, CA (US); Dhaval Shah, Mountain View, CA (US)

Correspondence Address: DARBY & DARBY P.C., P.O. BOX 5257, NEW YORK, NY, 10150-6257, US

(73) Assignee: NOKIA INC., Irving, TX

(21) Appl. No.: 10/603,916

(22) Filed: Jun. 24, 2003

(51) Int. Cl. H04M 11/00; H04Q 7/24; H04L 12/66

(52) U.S. Cl. 455/421; 370/338; 370/352

(57) ABSTRACT

The present invention discloses a methods and systems for securely connecting mobile nodes to an internal private network using IPsec based Virtual Private Network (VPN) technology. The system employs a proxy home agent (PHA) coupled to a home network associated with a mobile node that is located within a secure network, a home agent (HA) that is located outside of the secure network, and a VPN gateway to provide VPN services to a mobile device that changes its current address during the VPN session. The HA and PHA are configured to provide Mobile IP Home Agent functionality through a distributed system.

### FIELD OF THE INVENTION

This invention relates to network communications systems in general, and more particularly, to methods and systems for securely connecting mobile nodes to an internal private network using IPsec based Virtual Private Network (VPN) technology.

### BACKGROUND OF THE INVENTION

The family of Internet Protocols (IP) are the backbone of modern networking and maintaining interoperability with these standards ensures the broadest possible application of a given technology. IP is also adaptable and has been extended to provide additional functionality.

Of particular relevance, IP mobility provides a protocol for maintaining an IP session with a mobile device whose actual network connection and IP address might be hoping among different physical networks as the mobile device moves. The protocol defines a system to provide for the routing of a mobile device's data to the current location of the device. This is accomplished through the use of a Home Agent that monitors the permanent IP address and current location of the mobile device. The Home Agent essentially allows the mobile device to have a permanent address that is translated by the Home Agent into the mobile device's current address. This is accomplished through a process called tunneling. Tunneling refers to a process where new “to” and “from” information is added to the front of a packet to reroute it to a given location. Of course, the implementation of IP mobility requires additional overhead. This includes the extra data attached to the packets and the need to keep a record of the mobile device's current location.

Also of interest, IP security (IPsec) defines a protocol that enables the creation of Virtual Private Networks (VPNs) to ensure the security of transmitted information packets. A VPN gateway creates a tunnel secured by authentication and encryption that can be keyed from credentials provided by an authority entity, such as a key distributor or a public key infrastructure. IPsec VPNs rely on the IP address of the participating entities to create the described tunnel.

IP protocols are regularly used to create private networks. A typical secure network connects to outside resources, such as the public Internet, through a “demilitarized zone.” The secure network represents a localized LAN or WAN that operates apart from the publicly accessible Internet. A classic example would be an internal corporate network. Of course, users of the secure network would like access to the resources of the Internet at large. The secure network uses a firewall to maintain its security while allowing access to external resources. The firewall screens traffic passing between the secure network and the Internet to prevent unauthorized access or security breaches.

A corporation would also like to make certain information publicly available to the users of the Internet, e.g. the corporation's web site. To maintain security of the internal network this information typically resides on servers outside the secure network's firewall in a DMZ. The DMZ is the only portion of the corporate network that is “visible,” i.e. accessible, to outside users.

It is also advantageous to allow an Intranet's authorized users to access the secure network when they are not physically connected to it. However, the most efficient way for a user to establish a connection is by using the public Internet infrastructure. This would, for example, allow a user to work from home and access files residing on the secure network. This, of course, creates a security problem because it allows information from the secure network to travel over the public Internet where it is potentially accessible to others. The VPN authenticates the external user and secures information traveling to and from the secure network.

The IPsec VPN's reliance on the external user's IP address, however, makes it unsuitable for direct use in a mobile environment. Mobile devices using the IP mobility standard change their IP address as they move from one network to another. This could potentially happen many times during a relatively short time period. Using a traditional VPN the user would have to re-authenticate and re-establish its secure connection after each of these transitions. This result is cumbersome to the point of being unworkable.

### SUMMARY OF THE INVENTION

The present invention is directed at providing systems and methods for combining the IP mobility and VPN into an efficient system for providing secure connections to an internal network from an external mobile node. It accomplishes this without modifying the underlying protocols which are used. The system allows a great deal of flexibility in the placement of the network elements disclosed. Embodiments of the present invention can accomplish their goals without the need to change existing network elements. This is particularly advantageous because it allows a user to provide additional functionality without discarding and replacing currently useful equipment.

According to one aspect, the system and method utilize a home agent (HA) that registers the external mobile device, monitors its current location and directs data intended for the mobile device to its current location. The system also provides a proxy home agent (PHA) that receives transmissions sent to the mobile node inside the secure network and forwards the received data to a VPN gateway for secure transmission to the mobile node. The VPN gateway performs IPsec encapsulation of data en route to the mobile node and transfers that encapsulated data to the home agent for final delivery.

According to another aspect, the Security Association (SA) state maintenance is limited to a single location.

According to another aspect of the invention, minimal signaling is used such that the proxy entries in the PHA are updated by the HA using a mutual static security association. The signaling does not contain all of the Mobile Node signaling. Instead it includes only the messages used to maintain the proxy ARP cache entries.

According to another aspect of the invention, the VPN gateway and the HA are located within a single device within a DMZ.

According to a further aspect, the HA is a separate device from the VPN gateway.

According to yet another aspect, the HA is located within the firewall.

### BRIEF DESCRIPTION OF THE DRAWINGS

FIG. 1A shows a topology of the home agent module co-located with the VPN gateway;

FIG. 1B illustrates data packet flow from the CN to the MN;

FIG. 1C illustrates data packet flow from the MN to the CN;

FIG. 2A shows a topology of the home agent module co-located with a firewall;

FIG. 2B illustrates data packet flow from the CN to the MN;

FIG. 2C illustrates data packet flow from the MN to the CN;

FIG. 3A shows a topology of the home agent module situated on the same network as the VPN gateway;

FIG. 3B illustrates data packet flow from the CN to the MN;

FIG. 3C illustrates data packet flow from the MN to the CN; and

FIG. 4-8 show topologies for MIP/VPN/Firewall traversal; in accordance with aspects of the invention.

### DETAILED DESCRIPTION

In the following description of the various embodiments, reference is made to the accompanying drawings which form a part hereof, and in which are shown by way of illustration various embodiments in which the invention may be practiced. It is to be understood that other embodiments may be utilized and structural and functional modifications may be made without departing from the scope of the present invention.

Throughout the specification and claims, the following terms take the meanings explicitly associated herein, unless the context clearly dictates otherwise. The term “IP” means any type of Internet Protocol. The term “node” means a device that implements IP. The term “router” means a node that forwards IP packets not explicitly addressed to itself. The term “routable address” means an identifier for an interface such that a packet is sent to the interface identified by that address. The term “link” means a communication facility or medium over which nodes can communicate. The term DMZ refers to Demilitarised Zone—a part of network immediately outside a corporate network's firewall visible to the outside. The term “HA” refers to Home Agent—a network element in a mobile node's home address link defending the mobile node with ARP while the mobile node is roaming off-link. The term “Mobile Node” (MN) refers to a node that is configured to move away from its topologically correct address while communicating with other nodes still using that address.

The following abbreviations and terms are used throughout the specification and claims: ACL: Access Control List; ARP: Address Resolution Protocol; IPv4: Internet Protocol Version 4; IPv6: Internet Protocol Version 6; L2: Layer 2—Link layer; L3: Layer 3—Network Layer; and NAT: Network Address Translation.

Referring to the drawings, like numbers indicate like parts throughout the views. Additionally, a reference to the singular includes a reference to the plural unless otherwise stated or is inconsistent with the disclosure herein.

The present invention is directed at combining the IP mobility and IP security (IPsec) protocols to establish an efficient system for securely connecting mobile nodes to an internal network. The present invention can be implemented in IPv4, IPv6 or future versions of the IP protocol. This combination is achieved through the use of a Home Agent (HA) and a Proxy Home Agent (PHA) to efficiently secure the session of a freely roaming mobile node. Foreign Agents (FAs) may or may not reside in the Mobile nodes visited network without affecting the solution. For purposes of the discussion, the functionality of the FA is not modified so it is not discussed, herein.

A mobile node is embodied by hardware devices that can move about while being used. Examples of these devices include PDAs, mobile handsets, tablet computers, etc. To practice the present invention a particular mobile device typically contains hardware and software programmed to carry out the IP mobility and the IPsec protocols. The mobile node is assigned a permanent IP address to use on the secure network, e.g., its corporate Intranet. This address, however, is not accessible to the mobile node when it roams beyond the confines of the secure network and connects to other Internet networks. To obtain access to the secure network the mobile node employs the IP mobility and IPsec protocols to establish a secure connection to its home Intranet. This connection is facilitated by the Home Agent and a Proxy Home Agent.

The Home Agent provides IP mobility connectivity for the secure network's mobile nodes. The Home Agent maintains an external IP address that is accessible to the public Internet. This provides an access point that enables a mobile node to establish an IP mobility connection. In practice, the Home Agent is embodied by software and/or hardware that is network connected and implements an IP mobility protocol. This functionality can be provided, using standard design techniques, in a stand alone hardware device or it can be integrated into networking components that provide other functionality. The Home Agent's IP mobility responsibilities include establishing a connection with the mobile node, creating a security association with the mobile node, and maintaining a record of the mobile node's current location. Other, and further functions of the Home Agent are described throughout this specification.

The Proxy Home Agent monitors a mobile node's permanent address when the device leaves the secure network. The Home Agent notifies the PHA that a particular mobile node is connecting from outside the secure network. The PHA can then keep a list of these nodes and forward all incoming traffic sent to the node's internal permanent IP address. The PHA is embodied by software and/or hardware to perform the above described function. Just as described with respect to the Home Agent, the PHA's functionality can be incorporated in a stand alone device or combined with other networked devices. Other, and further, aspects of the PHA are described throughout this specification.

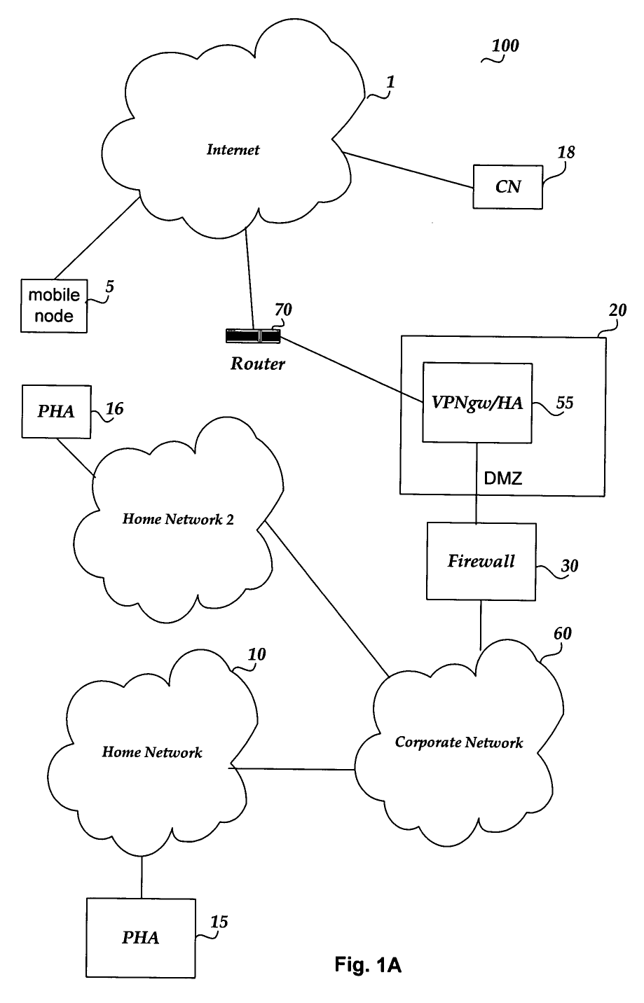

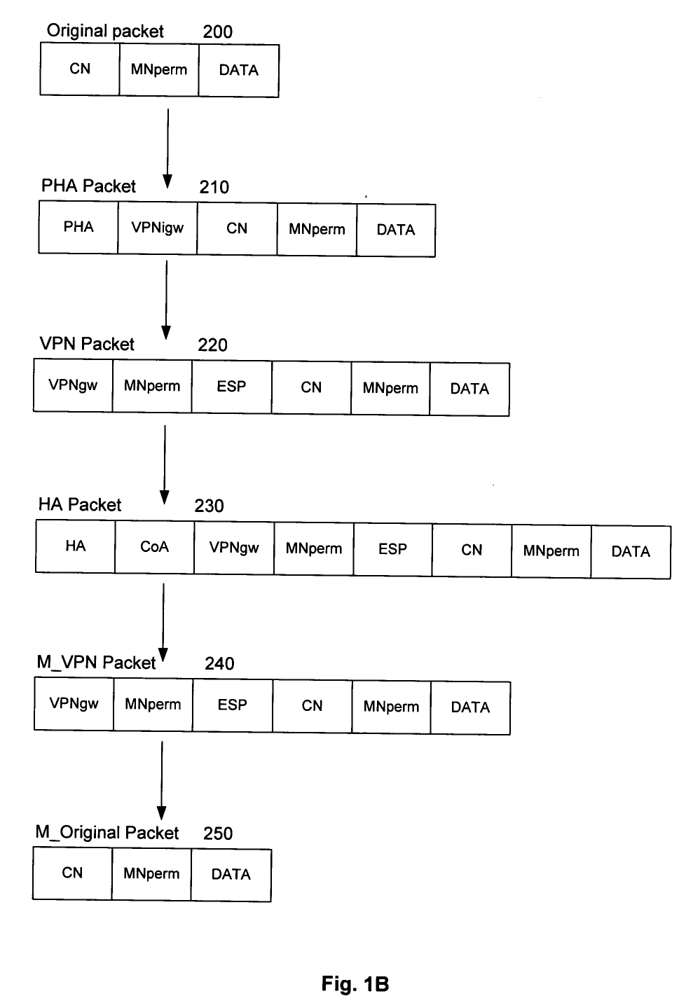

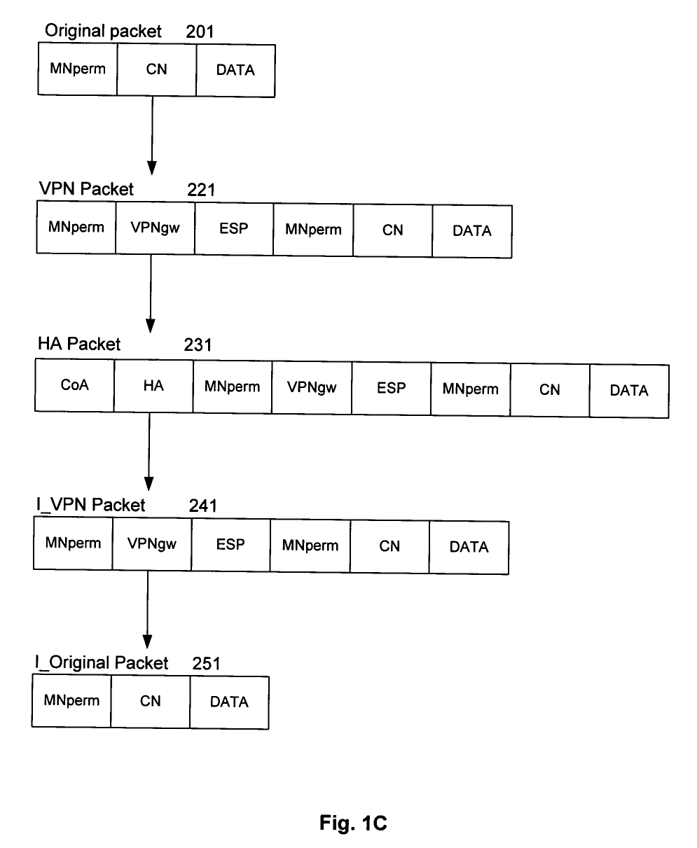

FIGS. 1A-1C show an embodiment of the invention, in accordance with aspects of the present invention.

FIG. 1A shows a topology of the home agent module co-located with the VPN gateway, in accordance with aspects of the invention. Mobile node 5 is a mobile device belonging to a secure network, home network 10, but currently connecting via public Internet 1. The functionality of a conventional Mobile IP home agent is divided into two parts: the Proxy Home Agent and the Home Agent. The signaling and tunneling functionalities of a conventional Mobile-IP home agent reside on the HA. PHA 15 is configured to include the proxying functionality typically found in a Mobile IP HA. Proxy Home Agent (PHA) 15 is coupled to home network 10 and is within a secure network. According to one embodiment, a separate PHA is coupled to each home network located within the secure network and a single HA is used for each secure network. For example, referring to the figure PHA 16 is coupled to home network 2. Therefore, there may be multiple PHA's for a secure network but only one HA for the secure network. Other devices also reside within the secure network and communicate with each other over the network. Correspondent node 18 represents an arbitrary network member that mobile node 5 is communicating with. CN 18 may be coupled to any network. For example, CN 18 may be coupled to Internet 1, Corporate Network 60, Home Network 10, or home network 2. Firewall 30 represents a device that bridges the Intranet and external entities. Firewall 30 can be embodied by any known hardware and/or software used to create firewalls. DMZ 20 represents networking infrastructure maintained by the owners of the secure network, but publicly accessible, i.e. visible, over the Internet. As shown, Firewall 30 connects DMZ 20 and the secure network to only allow authorized communications into the Corporate Network's secure environment. Home network 10 and home network 2 is associated with corporate network 60. VPNgw/HA 55 resides in DMZ 20 and provides externally accessible connections for the mobile node. VPNgw/HA 55 is a single device that performs both IP mobility and IPsec VPN gateway functions.

The functions preformed in the various elements are best described through reference to the packet state diagrams depicted in FIGS. 1B and 1C.

FIG. 1B illustrates data packet flow from the CN to the MN, in accordance with aspects of the invention.

Original packet 200 represents the actual IP packet sent by a correspondent node to the mobile node. The original packet has a header containing the correspondent node's address (CN), the permanent address of the mobile node (MNperm) and the transmitted data. The CN sends the data to the mobile node's permanent address. As discussed above, the CN may be located anywhere. For example, the CN can be inside the Corporate Network or even in the Internet. When the CN sends a packet to the MN, it is received on the MN's home network by the PHA on behalf of the MN.

Proxy Home Agent 15 monitors the network to help ensure that all packets are delivered to the associated mobile nodes. As shown in FIG. 1A, mobile node 5 is coupled to the Internet, and PHA 15 monitors the network for packets destined to the mobile node. One of the duties of the Home Agent is to send data to the PHA indicating that a particular mobile node is currently connecting from outside the Intranet. According to one embodiment, the communication between the PHA and the HA is secured via static security association. This information is used to create a list on the PHA indicating what mobile IP addresses to monitor to forward off the secure network. Accordingly, the PHA will accept the original packet 200, sent by the correspondent node, in place of the mobile node.

The PHA then sends the original packet 200 to the VPN/HA. The packet from the PHA to the VPN gateway is IP-in-IP encapsulated. As shown, PHA packet 210 simply acts as a tunnel with the original packet encapsulated in address routing information indicating VPNigw as the destination and PHA as the origin. VPNigw represents an address that is directly connected from the secure network into the VPN/HA and only carries secure traffic internal to the secure network.

The VPN/HA's receipt of a packet from the PHA on the VPNigw identifies the packet as an out-going packet being securely sent to a mobile node. First, the VPN gateway functionality of the VPN/HA strips the header added by the PHA. The VPN gateway then performs IPsec encryption to create VPN packet 220. The details of this procedure are described by the IPsec protocol. The VPN session established is created between the VPN gateway and the permanent address of the mobile node 5. The permanent address does not change. Therefore, the session is not affected by the mobile node's changing its current IP address as the user moves about. As can be seen, the VPN packet contains the entire original packet, albeit in encrypted form, an ESP field that contains information regarding the security used, and routing information to the permanent address of the mobile node from the VPN. These packets are not ready to be transmitted to the mobile node because they are addressed to the mobile node's permanent address not its current address.

The Home Agent functionality of the VPN/HA establishes the IP mobility tunnel to the current address of the mobile device. Thus, the VPN packet is handed off to the Home Agent. Note that the embodiment shown in FIGS. 1A-1C describes a HA and VPN that are co-located in a single device. Accordingly, the transfer of data between them does not require an IP transmission. The HA connects to the mobile device and establish an IP mobility session. This step is accomplished according to the standards set by the IP mobility protocol. As the mobile node moves and changes its IP address it updates the HA according to the IP mobility protocol. The tunneling is accomplished by appending new routing information to the VPN packets to create HA packet 230. Reference to the figures shows that the current address of the mobile node is represented by its care-of-address (CoA), this follows the conventions defined by the IP mobility protocol. The return address is the public address of the HA. With the appropriate CoA routing information the HA packets are transmitted to the mobile device.

The process is completed by the mobile node upon receipt of the HA packets. The mobile node strips the HA routing information off the packets, through IP mobility decapsulation. This creates M_VPN packet 240 that is identical to the VPN packet. Next, the mobile node performs decryption according to the IPsec protocol to obtain a M_Original packet 250 that is identical to the original packet.

FIG. 1C illustrates data packet flow from the MN to the CN, in accordance with aspects of the invention. Original Packet 201 is analogous to the original packet in the previous example, except the address information is reversed because the packet is traveling in the opposite direction. After creating original packet 201 the mobile node performs IPsec encryption and addressed the encrypted VPN packet 211 to the VPN. Again, the contents are analogous to the contents of the VPN packet from the previous example.

The mobile node, however, cannot send this packet directly to the VPN gateway because it is roaming and must communicate using the IP mobility protocol. A reason for this is that the mobile nodes VPN session is established using the mobile nodes permanent address, so this address must be the return address of the packet received by the VPN gateway. The mobile node, therefore, performs a reverse mobility tunneling procedure between itself and the HA, thereby creating HA packet 231. Just as in the previous example, it is the HA packet that is actually transmitted over the Internet.

Upon receipt of the HA packet the Home Agent removes the IP mobility tunneling header to create I_VPN packet 241, which is sent to the VPN gateway. The IPsec functionality decrypts and reveals I_Original packet 251. The original packet can then be forwarded to its final destination at the correspondent node (CN).

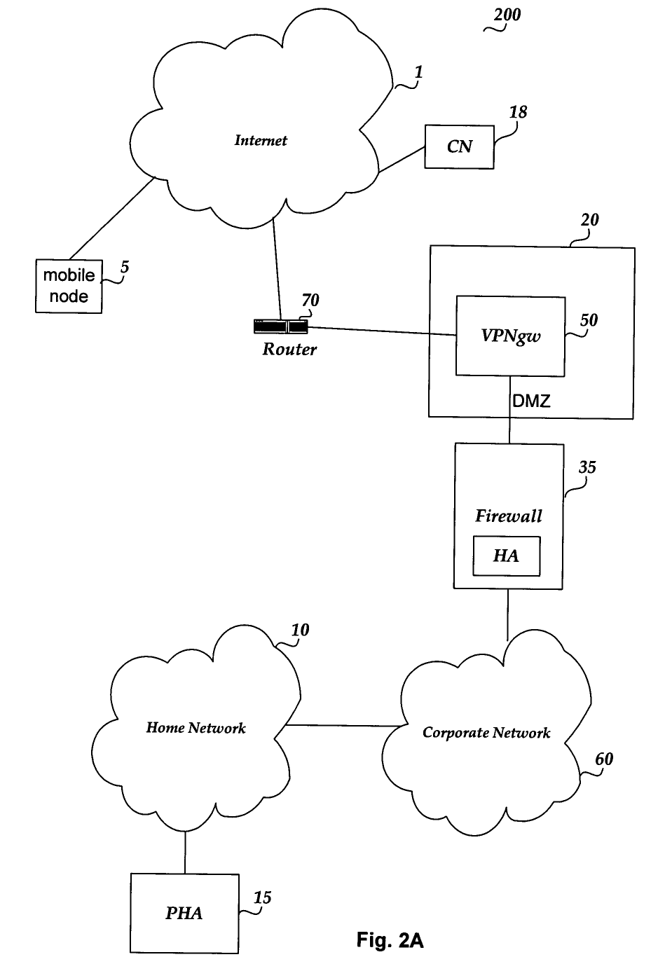

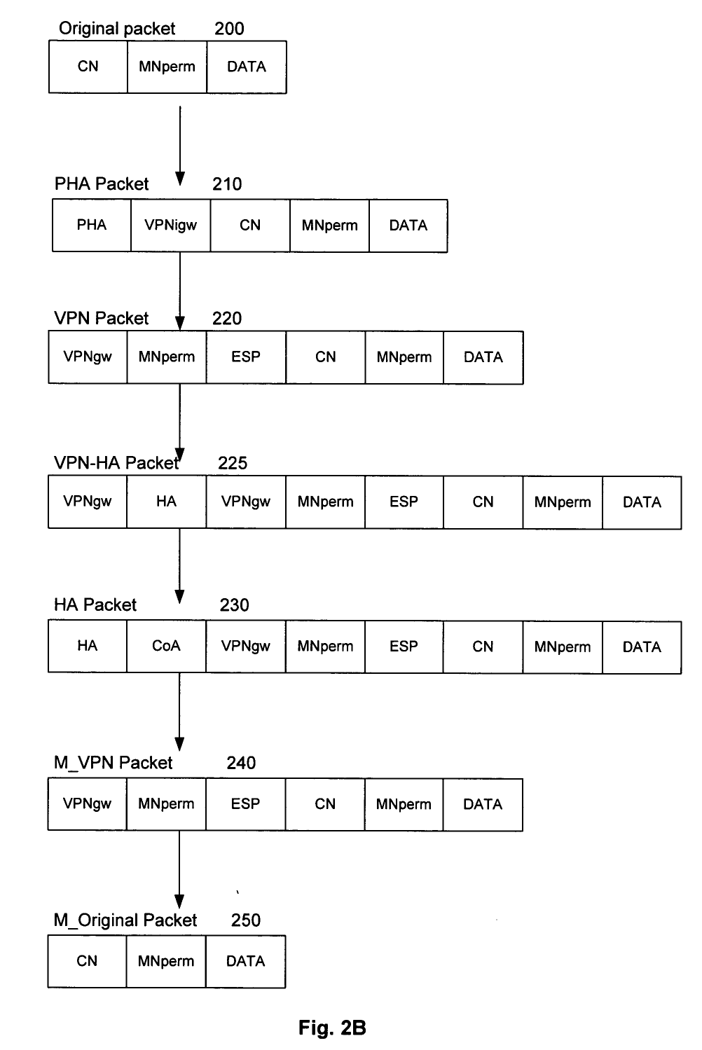

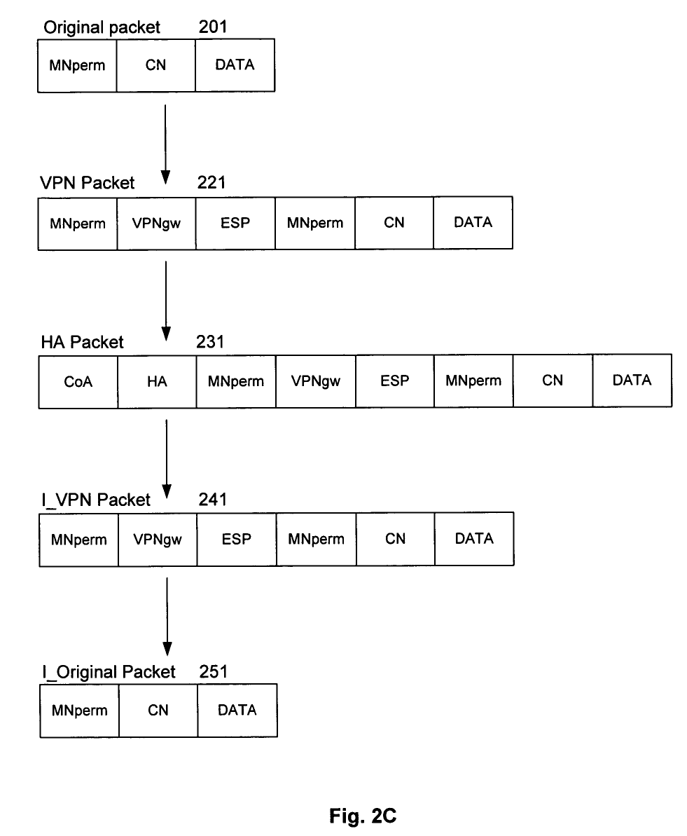

FIGS. 2A-2C disclose another embodiment of the present invention, in accordance with aspects of the invention. In this embodiment the Home Agent is co-located in the same device as the firewall, Firewall/HA 35, rather than being located with the VPN gateway as in the previous embodiment. The overall operation of the FIG. 2 embodiment is similar to the FIG. 1 embodiment. For example, PHA 15 performs the same function of monitoring the Intranet and forwarding packets destined for the mobile node 5 when it is away from the Intranet. Similarly, HA component of Firewall/HA 35 establishes the mobile IP connection with the traveling mobile node. While VPN gateway 50 maintains a secure connection.

FIG. 2B illustrates data packet flow from the CN to the MN, in accordance with aspects of the invention. The different topology slightly alters the packet manipulations to transmit packets from the CN to the MN. The first three steps are identical to the description provided for FIG. 1B. Original packet 200 is generated by the correspondent node; it is picked up by the PHA which creates the PHA packet 210; the PHA packet is forwarded to the VPN gateway which encrypts the packet to create the VPN packet 220. The next step differs since the VPN gateway and HA are no longer co-located, therefore, network routing is performed to transfer the packet to the HA. This is accomplished by creating VPN-HA packet 225, by adding routing information to the VPN packet. This packet is now suitable for transmission to the HA. The HA receives the VPN-HA packet and strips the routing information. The remaining three steps are identical to the last three steps described in FIG. 1B. The HA creates HA packet 230 to tunnel the information to the mobile node; the mobile node strips the tunnel information to create M_VPN packet 240; and the VPN packet is decrypted to retrieve M_Original packet 250.

FIG. 2C illustrates data packet flow from the MN to the CN, in accordance with aspects of the invention. The packet states for this process are identical to those described with respect to FIG. 1C, however, the process is slightly different. The functions performed by the mobile node are identical. Original packet 201 is created; it is encrypted according to IPsec to create VPN packet 221; and, reverse tunneling adds new routing information and creates the HA packet 231. Just as in the FIG. 1C example, the HA packets are sent to the Home Agent where the tunneling information is removed to reveal the I_VPN packet 241. This packet is then forwarded to the VPN gateway. This step is different, although only slightly, from the FIG. 1C example since the transmission from the HA to the VPN gateway is a network transmission since the VPN gateway and HA are now in separate devices. The VPN gateway receives the packets, decrypts them and passes the original I_Original packet 251 to the correspondent node.

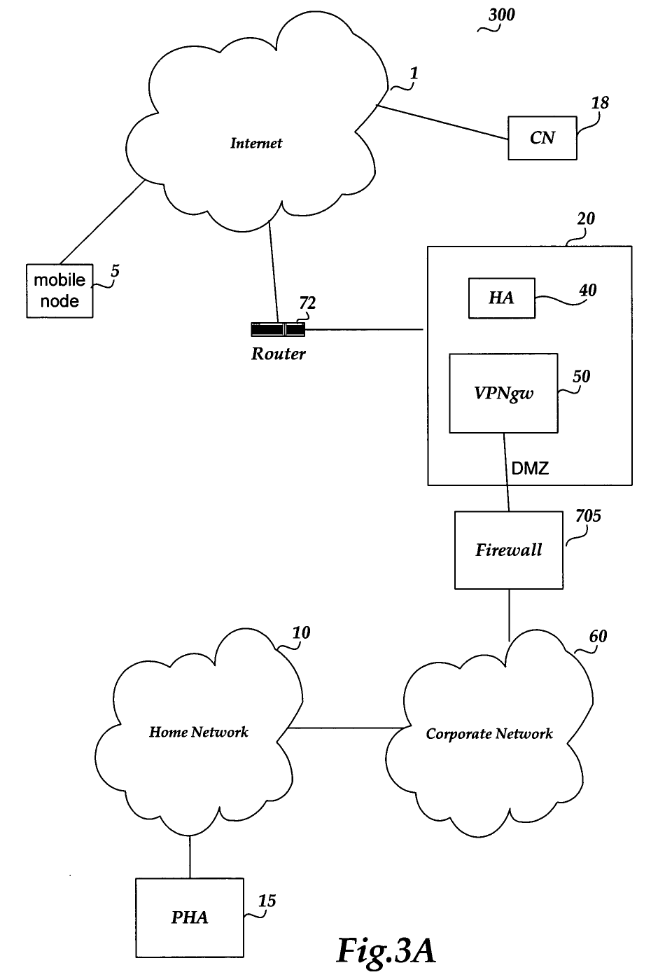

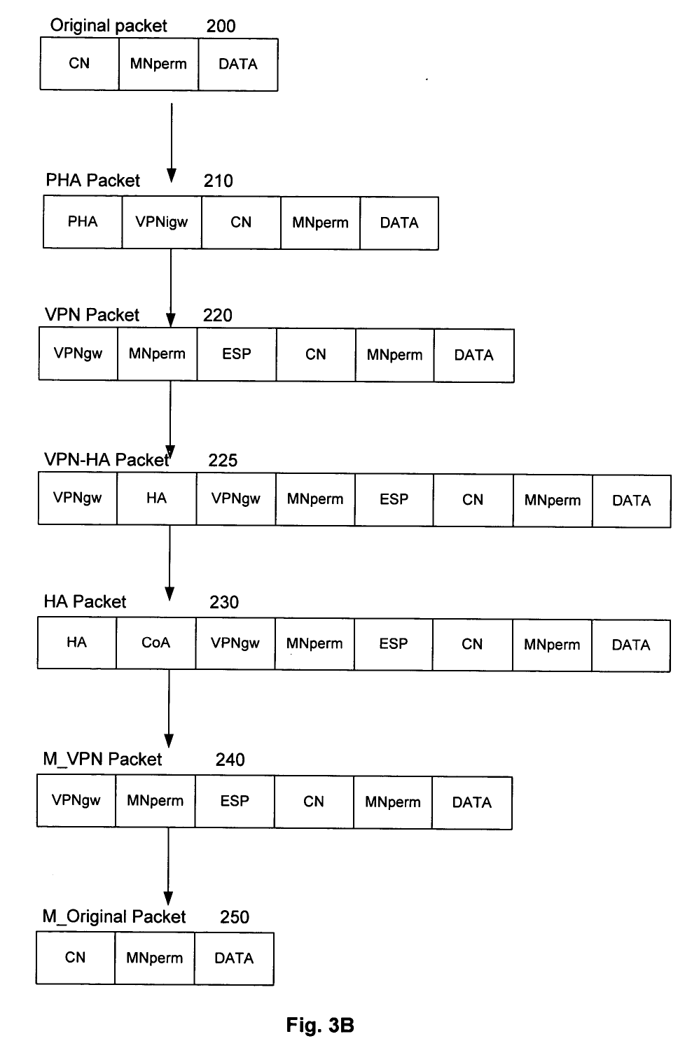

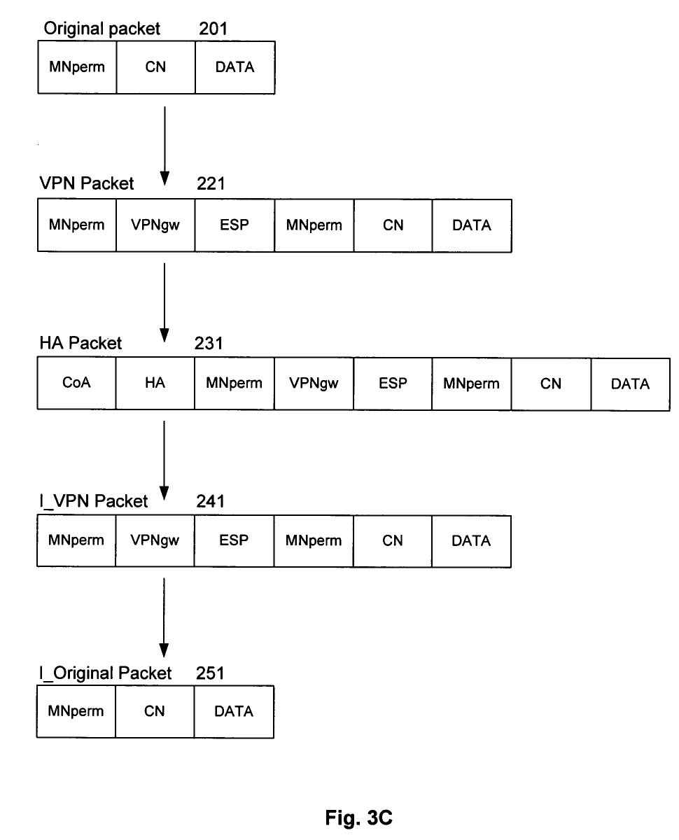

FIGS. 3A-3C disclose another embodiment of the present invention, in accordance with aspects of the invention.

FIG. 3A shows a topology of the home agent module situated on the same network as the VPN gateway, in accordance with aspects of the invention.

An advantage of this embodiment is that the Home Agent is a stand alone device residing in the DMZ. Since the HA in this embodiment is a separate device it can easily be integrated into an existing network's established infrastructure. The HA and PHA can be implemented on separate boxes without modifying other parts, such as the VPN gateway or Firewall.

FIG. 3B illustrates data packet flow from the CN to the MN, in accordance with aspects of the invention. Original packet 200 is generated by the correspondent node; it is picked up by the PHA which creates the PHA packet 210; the PHA packet is forwarded to the VPN gateway which encrypts the packet to create the VPN packet 220. Network routing is performed to transfer the packet to the HA. This is accomplished by creating VPN-HA packet 225, by adding routing information to the VPN packet. This packet is now suitable for transmission to the HA. The HA receives the VPN-HA packet and strips the routing information. The HA creates HA packet 230 to tunnel the information to the mobile node; the mobile node strips the tunnel information to create M_VPN packet 240; and the VPN packet is decrypted to retrieve M_Original packet 250.

FIG. 3C illustrates data packet flow from the MN to the CN, in accordance with aspects of the invention. Original packet 201 is created; it is encrypted according to IPsec to create VPN packet 221; and, reverse tunneling adds new routing information and creates the HA packet 231. The HA packets are sent to the Home Agent where the tunneling information is removed to reveal the I_VPN packet 241. This packet is then forwarded to the VPN gateway. The transmission from the HA to the VPN gateway is a network transmission since the VPN gateway and HA are now in separate devices. The VPN gateway receives the packets, decrypts them and passes the original I_Original packet 251 to the correspondent node.

A potential problem might arise when transmitting data from the VPN gateway in the DMZ to a correspondent node located inside the Corporate Network. The VPN gateway might be classified as an external element, and if so, when it sends the original packet off to the correspondent node it must pass through the Firewall. The Firewall will see a packet with an internal source IP address, i.e. the mobile nodes permanent address, arriving on its external interface. A properly configured Firewall would normally drop, i.e. prohibit, such a packet. If it did not, a malicious Internet user could spoof packets with that format and disrupt the Intranet. Other embodiments described herein, are directed at solving this problem.

In the last two embodiments described where the HA is a separate device, an assumption was made that the VPN gateway is capable of establishing an IP-in-IP tunnel between itself and the HA. This helps to ensure that the encrypted packets can be forwarded to the HA for further transmission to the mobile node after adding routing information according to the Mobile IP protocol. If the VPN gateway does not have this capability, however, then there is an alternative way to accomplish the same. This may be done by adding a static route on the VPN gateway such that all packets destined to MNperm are sent to the HA. The HA can then accept these packets by the use of proxy ARP entry.

This assumption was made since one of the advantages of the present invention is using the existing network elements without any changes if the HA functionality is on a separate device. Therefore if the existing VPN gateway in a customer's network does not have the capability of IP-in-IP tunneling then an alternate way to accomplish the same is provided.

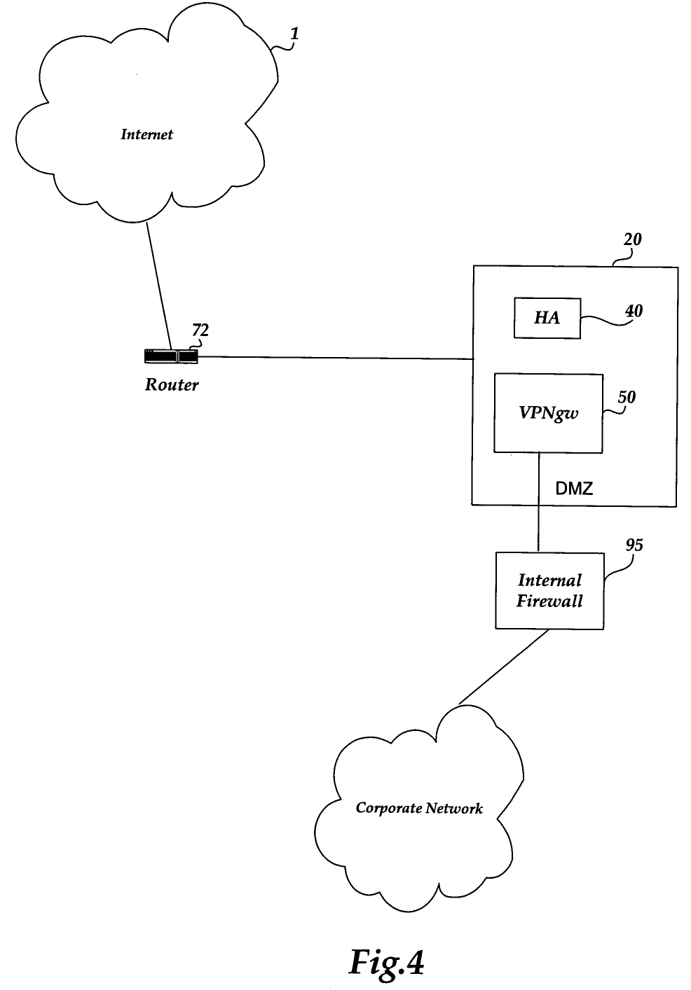

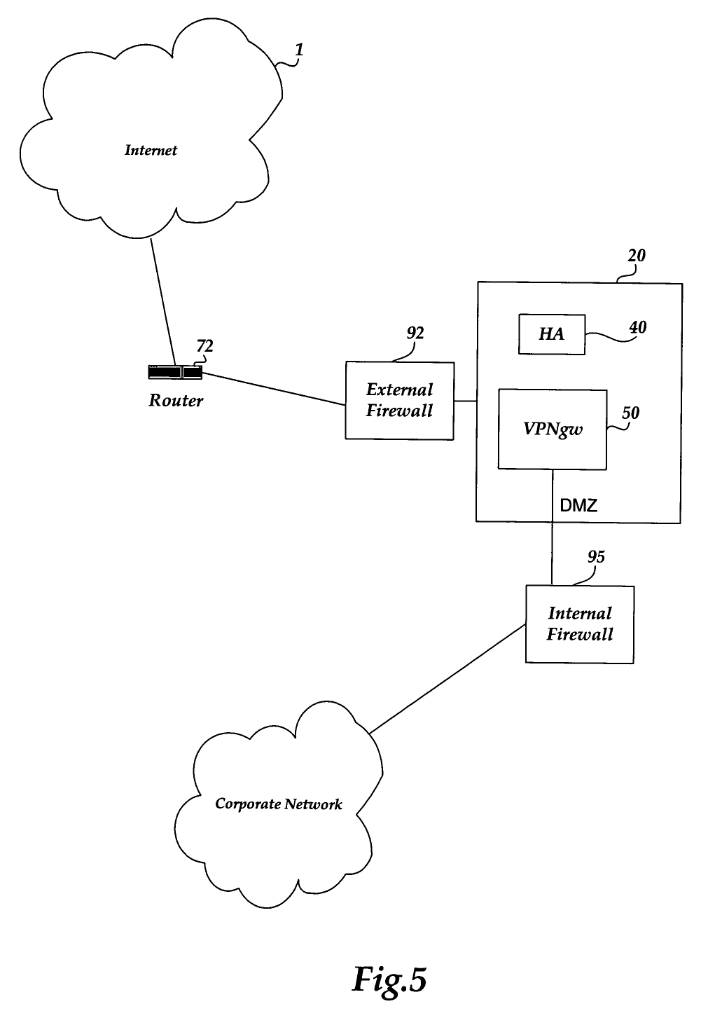

FIG. 4-8 show topologies for MIP/VPN/Firewall traversal; in accordance with aspects of the invention. FIG. 4 shows an exemplary topology for MIP/VPN/Firewall traversal; in accordance with aspects of the invention. Let us consider the scenario where the Home Agent is a separate device that resides on the same network as the VPN gateway as shown in FIG. 4. This implies that the Mobile IPv4 tunnel between the Home Agent and the Mobile Node ends outside the firewall protected corporate network. If the correspondent node resides inside the corporate network, the VPN gateway after decryption will forward the packet inside the corporate network through the firewall. However, the firewall, when it receives a packet that originated from a host inside the security domain on an external interface, will drop the packet. Creating rules to allow packets with source addresses that belong to a mobility network alone may be dangerous. This rule can be misused to attack the corporate network by spoofing packets. FIGS. 5-8 and the related discussion present four possible topologies based on existing corporate network infrastructure where the Home Agent can be placed. For each of these topologies configuration information is presented that will circumvent the firewall traversal problem. For purposes of discussion, an assumption is made that all Mobile Nodes belong to one home network and the address range is denoted as N. This address range is part of the corporation's internal address range. To be mobile, a node's IP address must be part of N.

FIG. 5 illustrates an exemplary topology for MIP/VPN/Firewall traversal in accordance with aspects of the invention. In this topology, external firewall 92 is configured such that it drops all packets that have source address that belongs to N. Additional checks are added to the Home Agent so that packets that it receives must have been IPsec encapsulated. Internal firewall 95 has rules that allow packets from the network N to go through the firewall. In this way only IPsec encapsulated packets from the Mobile node are allowed into the corporate network. The external firewall will take care of dropping spoofed packets.

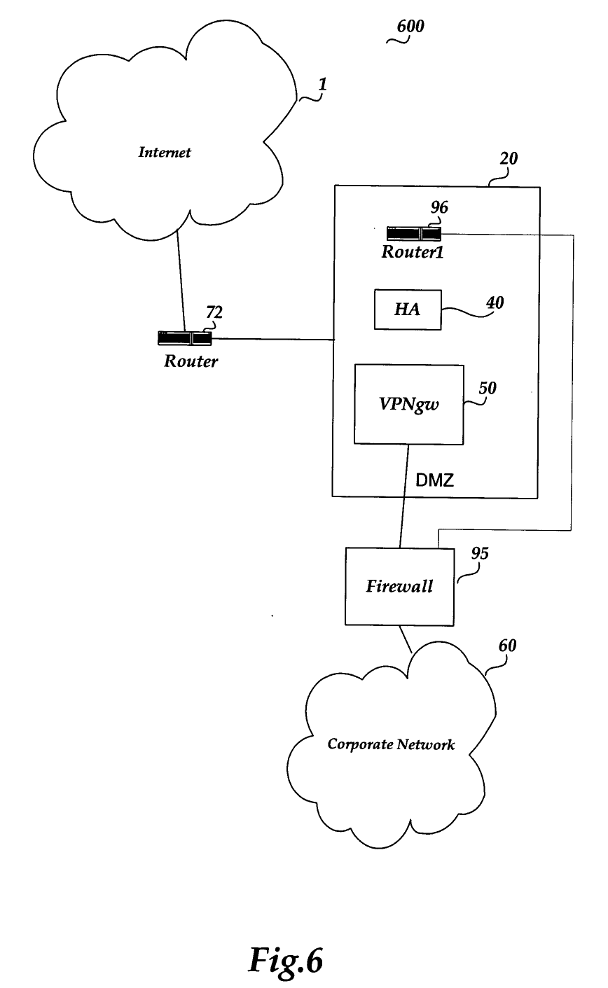

FIG. 6 shows a block diagram demonstrating another embodiment for solving the Firewall traversal problem. Once again, all mobile nodes in the system are assigned a permanent address in a given range N. In this embodiment router1 96 is added to the DMZ. Hackers can spoof packets with source addresses that belong to the address range N and attack the corporate network. Packets formatted this way will be sent directly to the firewall through router1 (96). These packets will not be sent via the VPN gateway or the Home Agent. Here an Access Control List (ACL)/firewall rule can be added to the firewall to allow packets with source address that belongs to network N from VPN gateway's MAC alone. All data packets from the MN destined toward nodes inside the corporate network will first go the Home Agent and then to the VPN gateway. It is from the VPN gateway that these packets are then forwarded through the firewall to the inside. Packets from router R1 to the firewall with source address in N will be dropped by the firewall. If the firewall allows only selected packets inside (based on MAC), then a denial-of-service type attack using source addresses from N can be prevented.

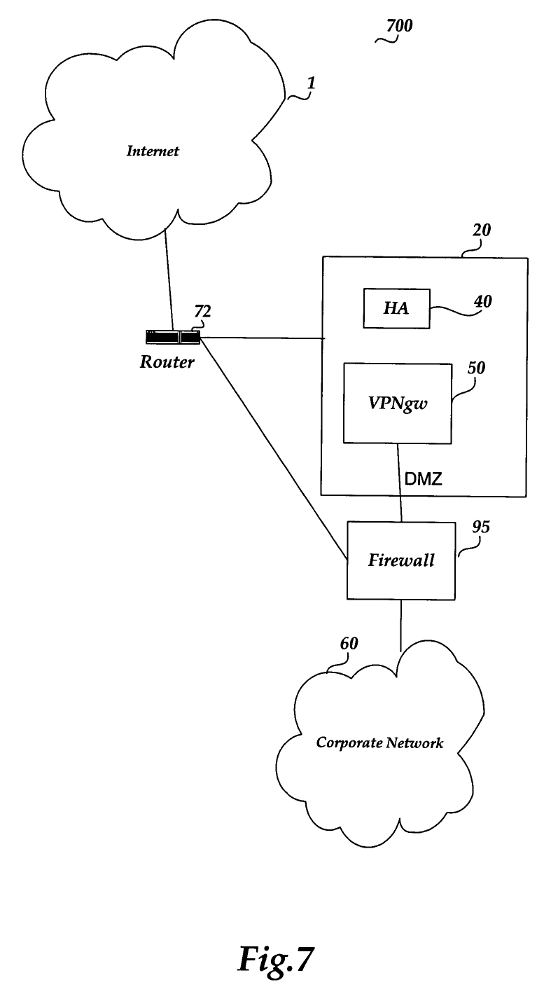

FIG. 7 shows an exemplary topology for MIP/VPN/Firewall traversal in accordance with aspects of the invention. Once again, all mobile nodes in the system are assigned a permanent address in a given range N. In this topology, router 72 is directly connected to the firewall. The VPN gateway and the Home Agent connect to a different interface of the router and firewall. The firewall is configured such that it considers the interface with which it connects to the VPN gateway as internal. Packets with a source address that belongs to the address range N received on this internal interface will not be dropped. By default, all packets are sent to the firewall. All packets with source address that belong to N received by firewall on the external interface are dropped. All VPN encapsulated packets are forwarded to the VPN gateway. If a Security Association (SA) exists, the packet is decrypted and forwarded to the firewall on the internal interface. Otherwise the packet is dropped. All Mobile IPv4 and VPN encapsulated packets first reach the Home Agent. These are then forwarded to the VPN gateway and then to the corporate network through the firewall's internal interface. The VPN gateway ensures that it receives only VPN encapsulated packets on the external interface. All other packets that it receives on the external interface are dropped.

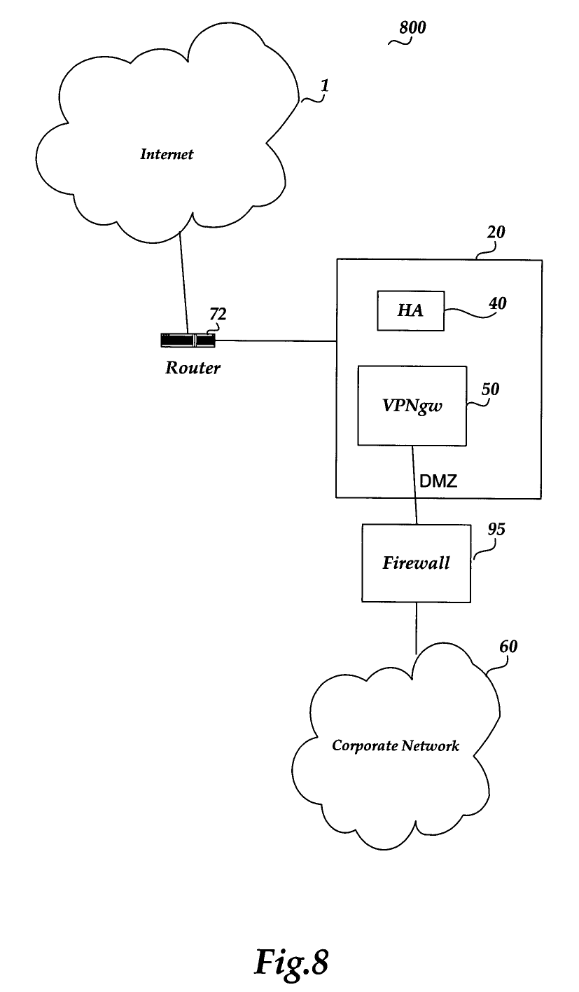

FIG. 8 illustratres an exemplary topology for MIP/VPN/Firewall traversal in accordance with aspects of the invention. This topology is very similar to the topology illustrated in FIG. 5, except that the external firewall is not present. To facilitate the firewall to allow packets from the Mobile Nodes to reach destinations inside the corporate network, a rule is added to allow such packets to pass through. To prevent spoofed packets from entering into the corporate network, Access Control Lists (ACLs) are created on the router to drop packets that have source address that belong the address range N. This prevents spoofed packets from reaching the VPN gateway or the Home Agent and hence the firewall. Since packets that are spoofed have been already filtered by the router, the firewall can safely allow packets from the address range N inside.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact instruction and operation illustrated and described herein. Accordingly, all suitable modifications and equivalents that may be resorted to are intended to fall within the scope of the claims.

What is claimed is:

1. A system for providing secure mobile connectivity that implements Mobile IP Home Agent functionality via distributed components, comprising:
a mobile node belonging to a home network located within a secure network; the mobile node having a network interface configured to communicate with other nodes;
a router configured to forward packets between networks;
a Proxy Home Agent (PHA) connected to the home network and located within the secure network that is configured to provide a portion of the Mobile IP Home Agent functionality;
a Home Agent (HA) located outside of the secure network that is configured to provide another portion of the Mobile IP Home Agent functionality; and
a VPN gateway coupled to the router and the secure network and configured to work in conjunction with the PHA and the HA.

2. The system of claim 1, wherein the VPN gateway and the HA are located within a single device within a DMZ.

3. The system of claim 1, further comprising a firewall coupled to the secure network and the VPN gateway; wherein the HA is located within the firewall.

4. The system of claim 1, wherein the HA is a separate device from the VPN gateway.

5. The system according to claim 1, further comprising:
a DMZ located outside the secure network, wherein the VPN gateway and the HA reside in the DMZ; a first firewall between the secure network and the DMZ; a second firewall between the DMZ and an external network configured to deny communications from the external network with a source address in the known range; and wherein the mobile node has a permanent address in a known range.

6. The system according to claim 1, further comprising:
a DMZ located outside the secure network, wherein the VPN gateway and the home agent reside in the DMZ; a first firewall between the secure network and the DMZ; wherein the mobile node has a permanent address in a known range and the first firewall is programmed to deny all communications from the DMZ with a source address in the known range; and wherein the VPN gateway has a direct connection to an internal interface of the first firewall such that the first firewall considers the VPN gateway transmitted data as internal to the secure network.

7. The system of claim 1, further comprising a DMZ comprising a first router coupled to a second router that is coupled to a firewall, the VPN gateway coupled to the first router and the firewall; the HA coupled to the router.

8. The system of claim 7, wherein packets from the MN destined toward nodes inside the secure network first go the HA and then to the VPN gateway that is configured to forward the packets through the firewall to the secure network.

9. The system of claim 8, wherein packets from the second router to the firewall having a source address in a known range are dropped by the firewall.

10. The system according to claim 1, wherein the router is directly connected to a firewall and the VPN gateway and the HA connect to a different interface of the router and the firewall.

11. The system of claim 10, wherein the firewall is configured such that it considers the interface with which it connects to the VPN gateway as an internal interface and packets with a source address that are outside of a known address range received on the internal interface are dropped, and packets with a source address that are within the known address range that are received by the firewall on an external interface are dropped.

12. The system of claim 11, wherein VPN encapsulated packets are forwarded to the VPN gateway and when a Security Association (SA) exists, the packet is decrypted and forwarded to the firewall on the internal interface and when a SA does not exist the packet is dropped.

13. The system of claim 12, wherein Mobile IP packets and VPN encapsulated packets first reach the Home Agent which are forwarded to the VPN gateway and then to the secure network through the firewall's internal interface.

14. The system of claim 1, further comprising a firewall coupled to the secure network and the VPN gateway; wherein the router includes an access control list used to drop packets that have a source address that belong to a known address range.

15. A method for secure communication between a mobile node associated with a home network in a secure network and a correspondent node; comprising:
establishing a Proxy Home Agent (PHA) located within the secure network to monitor data directed to the mobile node;
establishing a Home Agent configured to create a security association with the mobile node;
collecting data directed to the mobile node;
packaging the collected data in a VPN secure tunnel to an internal address of the mobile node to create VPN packaged data; and
tunneling the VPN packaged data to a current address of the mobile node.

16. The method of claim 15, wherein the VPN secure tunnel follows the IP security protocol.

17. The method of claim 15, wherein the tunneling of the VPN packaged data to the external mobile node occurs according to the IP mobility protocol.

18. The method of claim 15, further comprising: packaging the collected data in an IP-in-IP tunnel and sending it to a VPN device for VPN encryption and tunneling the VPN packaged data to the current address of the Mobile node.

19. A system for secure mobile connectivity that implements Mobile IP Home Agent functionality via distributed components; comprising:
means for establishing a Proxy Home Agent (PHA) located within the secure network to monitor data directed to the mobile node;
means for establishing a Home Agent configured to create a security association with the mobile node;
means for collecting data directed to the mobile node;
means for packaging the collected data in a VPN secure tunnel to an internal address of the mobile node to create VPN packaged data;
means for tunneling the VPN packaged data to a current address of the mobile node;
means for the Home Agent to communicate to the PHA that the mobile node has moved outside its home network; and
means for the Home Agent to communicate to the PHA that the mobile node has come back to its home network; and
means for enabling the PHA to create and remove a proxy ARP entry for a permanent address associated with the mobile node.
